(19) United States
(12) Patent Application Publication
(10) Pub. No.: US 2010/0028635 A1
(43) Pub. Date: Feb. 4, 2010

(54) EDGE LAMINATED ROLL GOODS

(75) Inventors: Vishal Bansal, Overland Park, KS (US); Travis G. Stifter, Brooklyn Park, MN (US); Chad E. Brooks, Marshall, MO (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/182,445

(22) Filed: Jul. 30, 2008

(51) Int. Cl. B32B 7/02; B29C 47/06

(52) U.S. Cl. 428/213; 156/243

(57) ABSTRACT

A laminated article comprises a first web of material of a first width. A second web of material has a second width substantially equal to the first width. The second web is coextensive with the first web. The second web is laminated at a lateral portion to the first web. A permeable unlaminated portion extends transversely of the laminated lateral portion. The width of the laminated lateral portion is less than the half the first width.

### BACKGROUND

The invention relates generally to laminated stock material. In particular, the invention relates to roll goods laminated at an edge.

Roll goods are known. Roll goods are typically provided to a user as a relatively long sheet of material that is rolled up on itself or on a cylindrical core. During processing into a final or intermediate product, the sheet material of the roll goods is unrolled and cut to a length that is needed in subsequent processes.

One example of such a final product is a cartridge filter for fluids. The cartridge filter may include a pleated filter media element. The filter media can be a laminate of two or more layers of material. One of the layers of material can be expanded polytetrafluoroethylene (ePTFE) membrane that is laminated to a fabric substrate (nonwoven or woven). ePTFE membrane offers many advantages in fluid filtration applications and is very desirable to use in such applications.

ePTFE membrane is relatively fragile and difficult to handle and process. A laminate is generally needed for ease of handling and processing. However, lamination typically decreases the available flow area.

Thus, a need exists for providing multiple layer roll goods that can be handled and processed without detrimentally impacting the flow area of the roll goods.

### SUMMARY

A laminated article according to one aspect comprises a first web of material of a first width. A second web of material has a second width substantially equal to the first width. The second web is coextensive with the first web. The second web is laminated at a lateral portion to the first web. A permeable unlaminated portion extends transversely of the laminated lateral portion. The width of the laminated lateral portion is less than the half the first width.

A laminated article comprises a first layer of expanded polytetrafluoroethylene (ePTFE) having a first width. A second layer of meltblown ethylene chlorotrifluoroethlyene fabric has a width substantially equal to the first width. The first layer is coextensive with the second layer. The first layer is continuously laminated at opposite lateral portions to the second layer. A permeable unlaminated portion extends between the laminated lateral portions. The width of each of the laminated lateral portions is less than the half the first width.

Another aspect is a method of laminating sheet material. The method comprises the steps of providing a first web of material having a first width. A second web of material is provided and has a width substantially equal to the first width. The second layer is continuously laminated to the first layer at opposite lateral portions. A permeable unlaminated portion extends between the laminated lateral portions. The width of each of the laminated lateral portions is less than the half the first width.

### DRAWINGS

These and other features, aspects, and advantages of the invention will be better understood when the following description is read with reference to the accompanying drawings, in which:

FIG. 1 is a plan view of a laminated article, according to an aspect of the invention;

FIG. 2 is a cross-sectional view of the laminated article of FIG. 1 according to one aspect, taken approximately across the line 2-2 in FIG. 1;

FIG. 3 is a cross-sectional view of the laminated article, similar to FIG. 2, according to another aspect;

FIG. 4 is a cross-sectional view of the laminated article, similar to FIG. 2, according to yet another aspect;

FIG. 5 is a side schematic view of a lamination process according to one aspect of the invention;

FIG. 6 is an elevational view of a roll used in the lamination process illustrated in FIG. 5;

FIG. 7 is an elevational view of another roll used in the lamination process illustrated in FIG. 5;

FIG. 8 is a plan view of a laminated article, according to another aspect of the invention;

FIG. 9 is a cross-sectional view of the laminated article of FIG. 8, taken approximately across the line 9-9 in FIG. 8;

FIG. 10 is a plan view of a laminated article, according to yet another aspect of the invention;

FIG. 11 is a cross-sectional view of the laminated article of FIG. 10, taken approximately across the line 11-11 in FIG. 10; and

FIG. 12 is a cross-sectional view of the laminated article of FIG. 10, taken approximately across the line 12-12 in FIG. 10.

### DETAILED DESCRIPTION

Filtration media often includes at least one layer of material, such as expanded polytetrafluoroethylene (ePTFE) membrane, that is relatively fragile and difficult to handle and process in downstream conversion processes. One example of such product that would use such filtration media is a cartridge filter. The ePTFE membrane is generally laminated to a nonwoven or woven fabric substrate. The lamination process, however, reduces the fluid permeability of the filtration media. In order to maximize the fluid permeability of the laminate that can be easily handled in downstream processes, a multi-layer roll good product was developed that has the at least one outer edge laminated together. The remainder of the roll goods is unlaminated to provide maximum flow, or fluid permeability, therethrough.

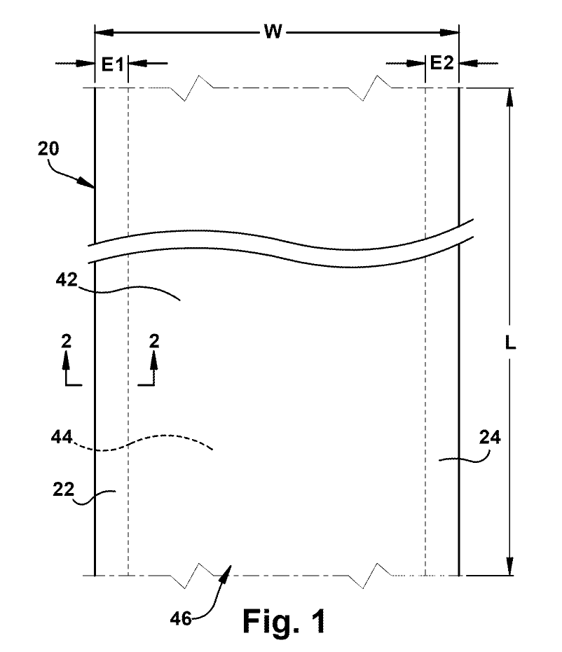

One aspect of the invention provides a multi-layer laminated article 20 (FIG. 1) laminated together at least at one edge 22 or 24 and preferably at its two outermost edges 22 and 24. Such a laminated article 20 allows easy handling and processing as filtration media that has a relatively high flow area located between the two outermost lateral edges 22 and 24.

The laminated article 20 includes a first layer or web 42 of material with a first width W. The laminated article 20 also includes a second layer or web 44 of material that has a second width that is substantially equal to the first width W. The first web 42 overlies the second web 44 and is coextensive with the second web. The second web 44 preferably is continuously laminated at opposite lateral portions or its outermost edges 22, 24 to the first web 42. It will be apparent that the laminated edge portions 22, 24 could be formed in a discontinuous manner. A permeable unlaminated portion 46 extends between the laminated lateral portions. While only two webs 42, 44 are illustrated making up the laminated article 20, it will be apparent that any suitable number of webs or layers may be incorporated into the laminated article.

The terms “web,” “laminated article” and “roll good” are intended to mean sheet material that has a length L extending in a direction transverse to the width W. The length L is substantially greater than the width W. For example, the width W could be in the range of 10.5 inches to 26 inches and the length L could be on the order of 100 yards or more.

The first web 42 of the laminated article 20 is made from any suitable material for filtration substrates, such as a nonwoven meltblown ethylene chlorotrifluoroethlyene. Examples of other suitable materials that can be used are nonwovens like spunbond, spunlaced, dry laid or thermobonded thermoplastic, such as meltblown polypropylene, polyester, polyethylene or nylon. The laminated article 20 has the first web 42 and second web 44 of material laminated together for the length L of the laminated article at both lateral edge portions 22, 24. The laminated edge portions 22,24 preferably extend continuously for the substantially entire length L of the laminated article 20.

Preferably, the lamination is done by thermal lamination, as illustrated in FIG. 2, but any suitable lamination process could be used, such as ultrasonic, RF, laser and adhesive. The laminated article 20 has the first web 42 and second web 44 of material continuously laminated together at respective outermost lateral edges of the laminated web. The width E1, E2 of each of the laminated lateral portions 22, 24 is less than the half the first width W, preferably less than 25% of the first width and even more preferably less than about 15% of the first width. The unlaminated portion 46 has a relatively high flow rate or permeability therethrough and is, thus, very suitable for use as a filtration medium. The unlaminated portion 46 may be suitably formed into a pleated filtration medium for a filter cartridge.

The second web 44 of the laminated article 20 is preferably in the form of a microporous membrane. The microporous membrane is preferably made from a material such as expanded polytetrafluoroethylene (ePTFE). The second web 44 may be made from any suitable material, for example, polytetrafluoroethylene, polyolefin, polyamide, polyester, polysulfone, polyether, acrylic and methacrylic polymers, polystyrene, polyurethane, polypropylene, polyethylene, polyphenelene sulfone, and mixtures thereof.

An ePTFE membrane typically comprises a plurality of nodes interconnected by fibrils to form a microporous lattice type of structure, as is known. A suitable average size for the pores in the microporous ePTFE membrane may be in the range of 0.001 micron to 10 microns, and preferably in the range of 0.005 to 5.0 microns. Typically, the porosity (the percentage of open space in the volume of the membrane) of the microporous membrane is between about 50% and about 98%. Often the porosity of the microporous membrane of a laminated article 20 suitable for many filtering applications ranges from about 70% to about 95%, and preferably from about 80% to about 95%. The microporous membrane may be “functionalized” to be hydrophilic, and thereby very suitable for liquid filtration uses.

A laminated article 20 according to one aspect was made with the first web 42 of a meltblown substrate and the second web 44 of an ePTFE membrane. The meltblown substrate was made from 100 grams per square meter of nonwoven ethylene chlorotrifluoroethlyene (ECTFE) fabric under the trade name Halar® from Monadnock. The ePTFE membrane of the second web 44 had an average pore size of 0.2 micron. The laminated article 20 is very suitable for processing into liquid filter cartridges.

The laminated article 20 may have a width W of about 10.5 inches to about 12 inches depending on the desired finished product size. The widths E1. E2 of the laminated edge portions 22, 24 are preferably in the range of about half an inch to about one inch, but can be of any suitable width. The ePTFE membrane of the second web 44 is continuously laminated to the meltblown substrate of the first web 42 at the edge portions 22, 24. Maximum fluid permeability of the laminated article 20 through the unlaminated portion 46 is, thus, provided with a structure that can be processed in operations that convert, for example the laminated article into a pleated filtration medium for a filter cartridge.

In an aspect illustrated in FIG. 3, the laminated article 20a has the meltblown substrate of the first web 42a. The ePTFE membrane of the second web 44a is continuously and adhesively laminated to the meltblown substrate of the first web 42a at laminated edge portion 22a. A permeable unlaminated portion 46a still exists laterally inward of the edge portion 22a to provide maximum flow area. While only edge portion 22a of the laminated article 20a is illustrated as being adhesively laminated it will be apparent that the edge portion 24a (not shown) may be adhesively laminated as well. The laminated article 20a may be provided with a width W of about 10.5 inches to about 12 inches. The widths E1, E2 of the laminated edge portions 22a, 24a are preferably about half an inch to an inch, but can be of any suitable width.

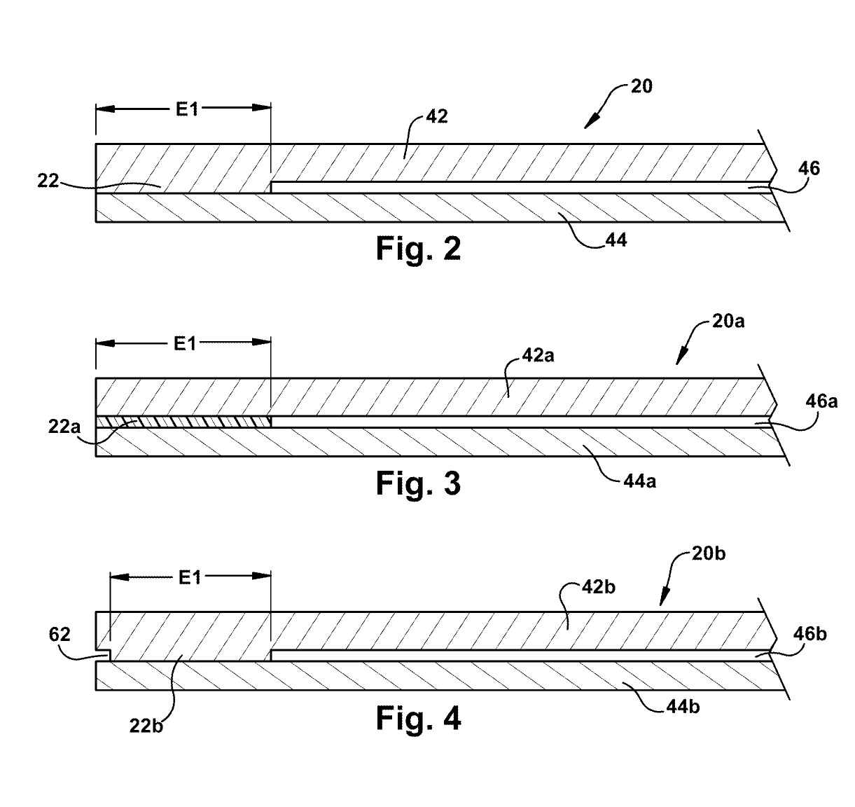

In an aspect illustrated in FIG. 4, the laminated article 20b has the meltblown substrate of the first web 4′b. The ePTFE membrane of the second web 44b is continuously laminated to the meltblown substrate of the first web 42b at laminated edge portion 22b by any suitable means so a relatively small unlaminated outer portion 62 exists laterally outside of the laminated edge portion. A permeable unlaminated portion 46b still exists laterally inward of the edge portion 22b to provide a maximum flow area. While only edge portion 22b is illustrated as being laminated it will be apparent that the edge portion 24b (not shown) may be laminated as well with a relatively small unlaminated portion laterally outside. The laminated article 20b may be provided with a width W of about 10.5 inches to about 12 inches. The widths E1, E2 of the laminated edge portions 22a, 24a are preferably in the range of about 0.375 inch to about 0.75 inch, but can be of any suitable width.

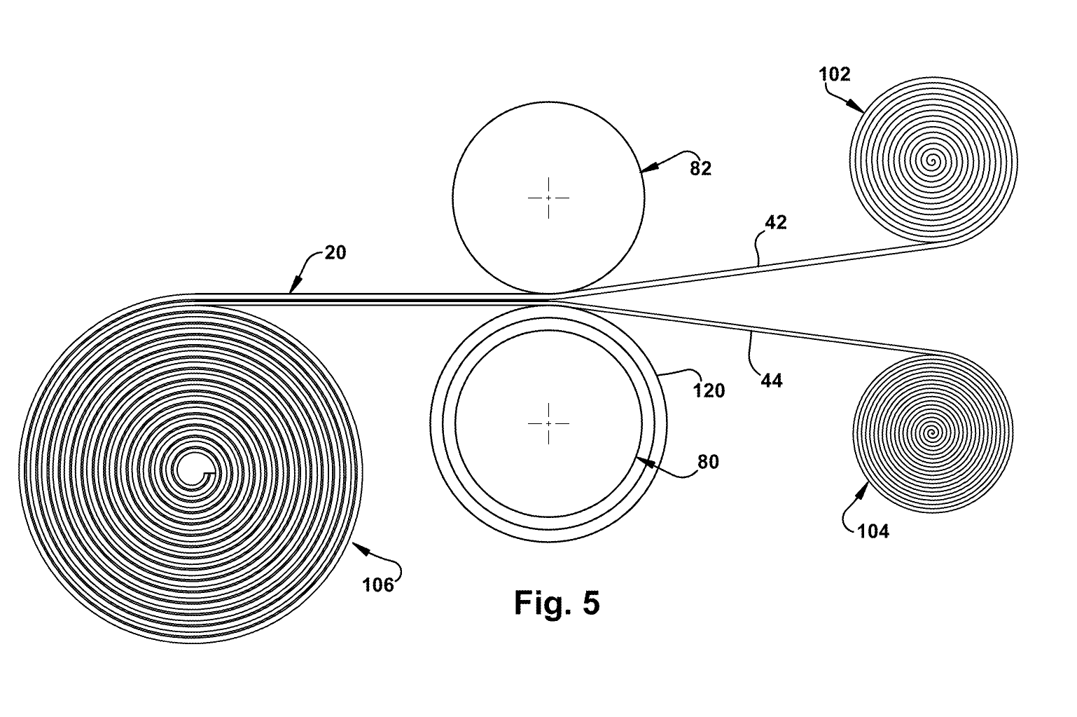

In another aspect of the invention illustrated in FIG. 5, the first web 42 and second web 44 are thermally laminated together to produce the laminated article 20 by rolls 80 and 82. The lower roll 80 is unheated or can be chilled and has raised portions 120 of a width approximately equal to the width of the laminated lateral edge portions 22, 24 of the laminated article 20. The upper roll 82 has a smooth outer surface and is capable of being raised to a lamination temperature that depends on the melting temperature or glass transition temperature of the material that the first web 42 is made from, such as 460° F. for the meltblown substrate. The roll 80, 82 are rotatable about their longitudinal central axes at a speed that assures sufficient residence time between the rolls to affect suitable lamination between the first web 42 and the second web 44.

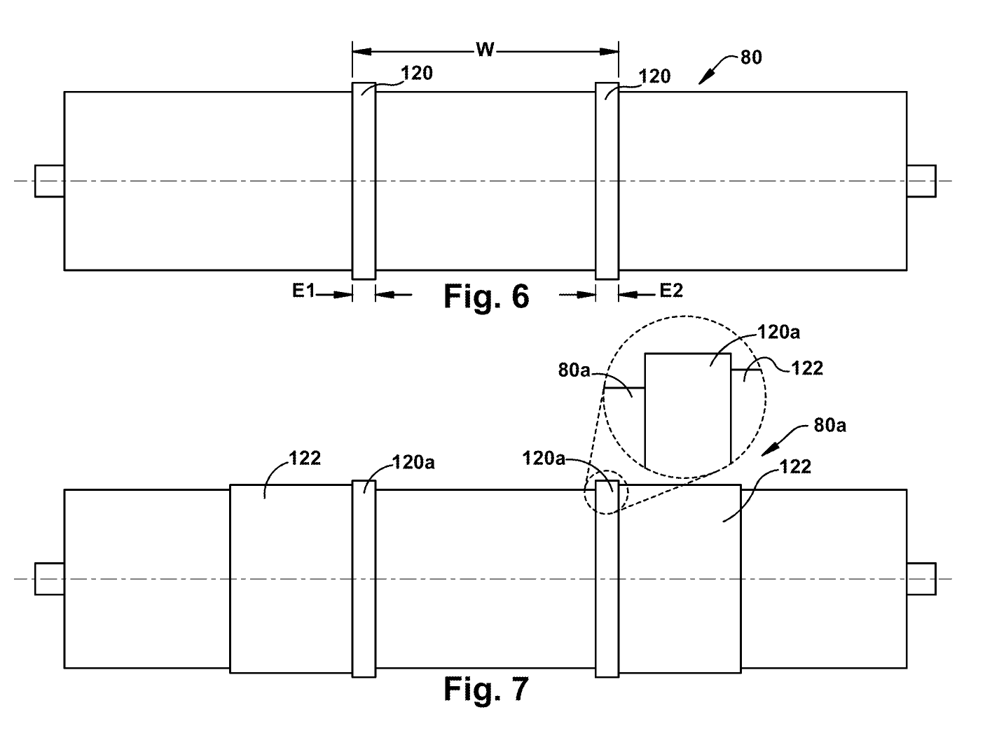

The first web 42 is fed from roll 102 to a location between the lamination rolls 80, 82. The second web 44 is fed from roll 104 to the same location between the lamination rolls 80, 82. A pair of raised portions 120 (FIG. 6) on the lower roll 80 engage and force a pair of portions of the second web 44 into the first web 42 against the upper roll 82. The pair of portions of the first web 42 that are engaged by the second web 44 melt, due to their intimate contact with the upper heated roll 82, into the second web to form the laminated edge portions 22, 24. A permeable unlaminated portion 46 extends transversely of and between the laminated edge portions 22, 24. The laminated article 20 is then rolled onto a roll 106 that can be used in downstream processes.

The roll 80 in FIG. 6, according to one aspect, is a hollow cylinder made from a metal, such as steel with a high temperature rubber coating applied to it. The roll 80 has a pair of raised portions 120 made from metal extending around the entire circumference of the roll 80. The laterally outermost edges of the raised portions 120 are spaced apart a distance substantially equal to the width W of the laminated article 20. The raised portions 120 also have respective widths substantially equal to or slightly greater than the widths E1, E2 of the laminated edge portions 22, 24 of the laminated article 20.

The roll 80a illustrated in FIG. 7, according to another aspect, is a hollow cylinder made from a metal, such as steel. The roll 80 has a pair of raised portions 120a made from a heat resistance tape, such as a fiberglass reinforced tape, that is wrapped around the entire circumference of the roll 80a. The roll 80a also has a pair of insulators 122 made from a heat resistance material, such as a Nomex® spunlace, that is wrapped around the entire circumference of the roll 80a. The insulators 122 are disposed axially outward of respective raised portions 120a. The outermost edges of the raised portions 120a spaced apart a distance substantially equal to the width W of the laminated article 20. The raised portions 120a also have respective widths substantially equal to or slightly greater than the widths E1, E2 of the laminated edge portions 22, 24 of the laminated article 20.

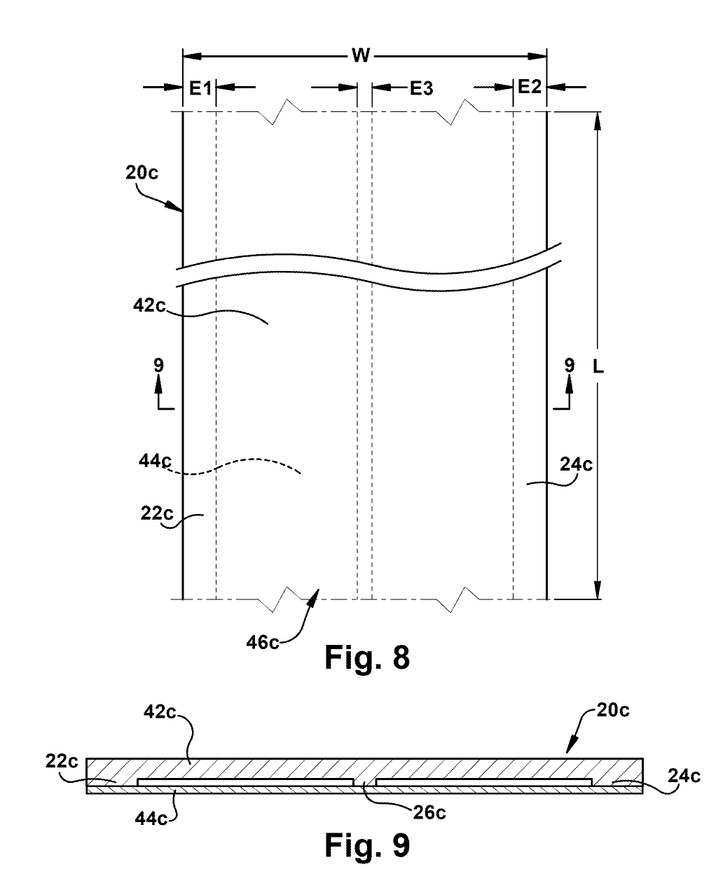

Another aspect of the laminated article 20c is illustrated in FIGS. 8-9. The laminated article 20c is similar in structure to the laminated article 20, described above. The laminated article 20c includes a first web 42c of material with a first width W. The laminated article 20c also includes a second web 44c of material that has a second width that is substantially equal to the first width W. The first web 42c overlies the second web 44c and is coextensive therewith. The second web 44c is continuously laminated at opposite lateral portions or its outermost edges 22c, 24c to the first web 42c. An unlaminated portion 46c extends between the laminated lateral portions.

The laminated article 20c also includes an intermediate laminated portion 26c extending the length L of the laminated article that interrupts or divides the unlaminated portion 46c. The intermediate laminated portion 26c is preferably a continuous lamination between the first web 42c and the second web 44c. The intermediate laminated portion 26c may have a width E3 greater than the widths E1, E2 of each of the laminated lateral portions 22c, 24c. The intermediate laminated portion 26c may also have a width E3 which is less than the widths E1, E2 of each of the laminated lateral portions 22c, 24c.

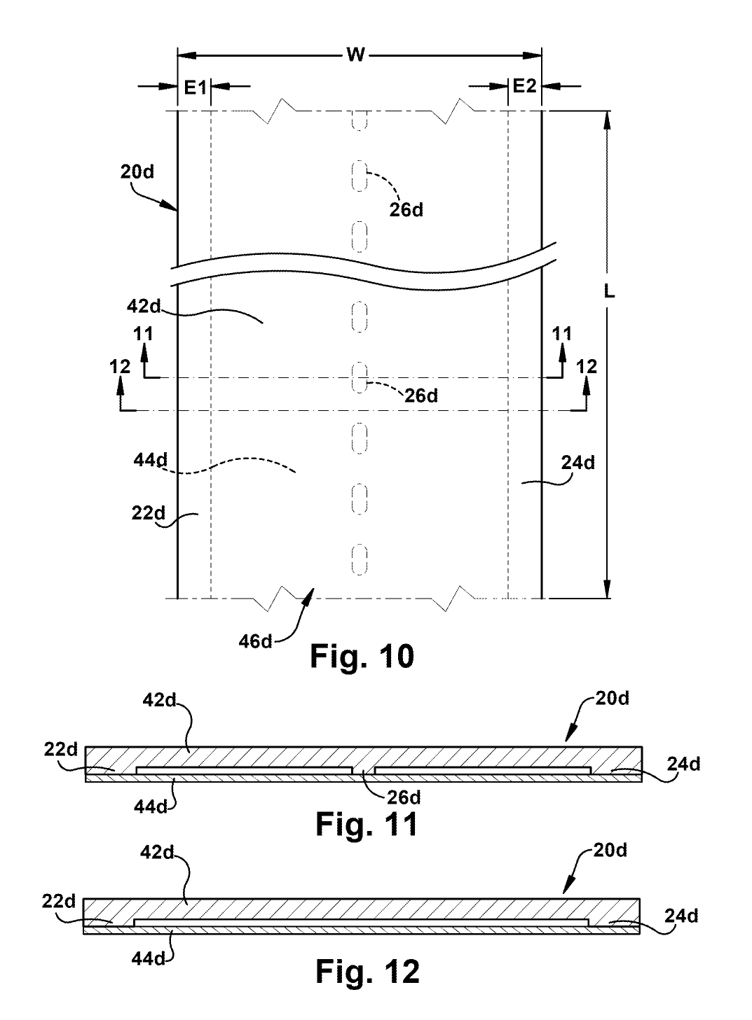

Another aspect of the laminated article 20d is illustrated in FIGS. 10-12. The laminated article 20d is similar in structure to the laminated article 20, described above. The laminated article 20d includes a first web 42d of material with a first width W. The laminated article 20d also includes a second web 44d of material that has a second width that is substantially equal to the first width W. The first web 42d overlies the second web 44d and is coextensive therewith. The second web 44d is continuously laminated at opposite lateral portions or its outermost edges 22d, 24d to the first web 42d. An unlaminated portion 46d extends between the laminated lateral portions.

The laminated article 20d includes an intermediate laminated portion 26d extending the length L of the laminated article that interrupts or divides the unlaminated portion 46d. The intermediate laminated portion 26d is preferably an alternating series of unlaminated portions and laminated portions between the first web 42c and the second web 44c. The intermediate laminated portion 26d may be formed by any suitable lamination method, such as by spot welding or lamination in the form of a discontinuous strip. The provision of the additional intermediate lamination portion 26d anywhere relative to the centerline of the laminated article 20d allows ease of handling of relatively wide roll goods. The intermediate lamination portion 26d may be located along the centerline of the laminated article 20d which could be a locating or guiding indicator for slitting the laminated article or as an enhanced bonding mechanism for stability in process handling of the laminated article.

Specific terms are used throughout the description. The specific terms are intended to be representative and descriptive only and not for purposes of limitation.

The invention has been described in terms of at least one aspect. The invention is not to be limited to the aspect disclosed. Modifications and other aspects are intended to be included within the scope of the appended claims.

Having described at least one aspect of the invention, what is claimed is:

1. A laminated article comprising:
a first web of material having a first width;
a second web of material having a width substantially equal to the first width and coextensive with the first web, the second web laminated at a lateral portion to the first web; and
a permeable unlaminated portion extending transversely of the laminated lateral portion;
the width of the laminated lateral portion being less than the half the first width.

2. The laminated article of claim 1 wherein the second web is laminated at opposite lateral portions to the first web and the unlaminated portion extending between the laminated lateral portions.

3. The laminated article of claim 2 further including an intermediate laminated portion between the laminated lateral edges and extending for the length of the laminated article, the intermediate laminated portion selected from the group of having a width greater than the width of each of the laminated lateral portions, having a width less than the width of each of the laminated lateral portions and having an alternating series of unlaminated portions and laminated portions.

4. The laminated article of claim 1 wherein one of the first and second webs of material is a microporous membrane.

5. The laminated article of claim 3 wherein the microporous membrane comprises expanded polytetrafluoroethylene.

6. The laminated article of claim 1 wherein the first and second webs of material are thermally laminated together.

7. The laminated article of claim 1 wherein the first and second webs of material are continuously laminated together at respective outermost lateral edges of the laminated article.

8. The laminated article of claim 1 wherein one of the first and second webs of material is a meltblown ethylene chlorotrifluoroethlyene.

9. The laminated article of claim 1 wherein the width of each of the laminated lateral portions is less than the 15 percent of the first width.

10. A laminated article comprising:
a first layer of expanded polytetrafluoroethylene having a first width;
a second layer of meltblown ethylene chlorotrifluoroethlyene fabric having a width substantially equal to the first width, the first and second layers being coextensive, the second layer continuously laminated at opposite lateral portions to the first layer; and
a permeable unlaminated portion extending between the laminated lateral portions;
the width of each of the laminated lateral portions being less than the half the first width.

11. The laminated article of claim 10 wherein the first and second layers of material are thermally laminated together.

12. The laminated article of claim 10 wherein the first and second layers of material are laminated together at respective outermost lateral edges of the laminated article.

13. The laminated web of claim 10 wherein at least one of the laminated lateral portions includes a continuous strip of lamination between the fabric and expanded polytetrafluoroethylene layers.

14. The laminated article of claim 10 wherein the width of each of the laminated lateral portions is less than the 15 percent of the first width.

15. A method of laminating sheet material, the method comprising the steps of:
providing a first web of material having a first width;
providing a second web of material having a width substantially equal to the first width; and
laminating the second layer to the first layer at opposite lateral portions;
in which a permeable unlaminated portion extends between the laminated lateral portions; and
the width of each of the laminated lateral portions is less than the half the first width.

16. The method of claim 15 wherein one of the first and second webs of material is a microporous membrane.

17. The method of claim 16 wherein the microporous membrane comprises expanded polytetrafluoroethylene.

18. The method of claim 15 wherein the first and second webs of material are continuously thermally laminated together at respective outermost lateral edges of the laminated web.

19. The method of claim 18 wherein the first and second webs of material are laminated together by a roll having raised portions of a width approximately equal to the width of the laminated lateral portions.

20. The method of claim 15 wherein one of the first and second webs of material is a meltblown ethylene chlorotrifluoroethlyene.
